(19) United States
(12) Patent Application Publication
(10) Pub. No.: US 2023/0360049 A1
(43) Pub. Date: Nov. 9, 2023

(54) FRAUD DETECTION FOR PRE-DECLINING CARD TRANSACTIONS

(71) Applicant: Hint, Inc., Pleasanton, CA (US)

(72) Inventors: Muthanna Nischal Ammatanda, Fremont, CA (US); Abraham Benjamin de Waal, San Jose, CA (US); Roman Tsymbalenko, Kharkiv (UA); Reddy Vijay Karthik Tummala, Pleasanton, CA (US)

(21) Appl. No.: 17/738,596

(22) Filed: May 6, 2022

(51) Int. Cl. G06Q 20/40; G06Q 30/02

(52) U.S. Cl. CPC G06Q 20/4016; G06Q 30/0201

(57) ABSTRACT

Systems and methods herein describe a fraud detection system. The fraud detection system receives a transaction request comprising a set of transaction data, accesses a set of historical transaction data from one or more historical data sources, generates a weight score for each data source of the one or more historical data sources, generates a fraud score for the set of transaction data, the fraud score generated using a machine-learning model trained to analyze the historical transaction data and the generated weight scores for the one or more historical data sources, determines that the fraud score surpasses a threshold score, and in response to determining that the fraud score surpasses the threshold score, voids the transaction request.

### TECHNICAL FIELD

Embodiments herein generally relate to fraud detection. More specifically, but not by way of limitation, embodiments relate to fraud detection for pre-declining card transactions, such as credit or debit card transactions.

### BACKGROUND

Credit card and debit card fraud is a rising form of identity frauds that is impacting people across the world. A fraudulent transaction may occur if a physical card is misplaced or stolen and used for unauthorized in person or online transactions. In some cases, criminals may steal a card number along with a personal identification number (PIN) and security code to make purchases. Card information can also be obtained online via data breaches that then allow criminals to make purchases without needing possession of the physical card.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a block diagram showing an example point-of-sale system for conducting transactions over a network, according to some embodiments.

FIG. 2 illustrates the training and use of a machine-learning program, according to some embodiments.

FIG. 3 is a flow diagram of an example method for detecting fraudulent card transactions, according to some embodiments.

FIG. 4 is a block diagram illustrating a software architecture, which can be installed on any one or more of the devices described herein, according to some embodiments.

FIG. 5 is a diagrammatic representation of the machine within which instructions for causing the machine to perform any one or more of the methodologies discussed herein may be executed, according to some embodiments.

### DETAILED DESCRIPTION

Systems and methods herein describe a fraud detection system used for pre-declining card transactions. The fraud detection system identifies and declines fraudulent transactions before the transaction has been processed instead of after. Traditional systems apply fraud detection mechanisms from the issuer's side (e.g., the bank) after the transaction has been processed. For some embodiments, the proposed fraud detection system is an improvement to traditional systems because it provides fraud detection capabilities before the transaction has been processed and mitigates complications in handling fraudulent transactions.

The fraud detection system leverages historical data to analyze an incoming transaction request. For example, the fraud detection system can intelligently analyze the validity of an incoming transaction request based on historical data, such as purchase patterns of a particular customer, trends in product purchase history, and the like.

The fraud detection system receives a transaction request. The transaction request may be received by a client device (e.g., a payment reader). The transaction request includes transaction data such as information about the payment instrument (e.g., credit card, debit card), the customer (e.g., personal identifiable information), the product (e.g., the price of the product, the quantity of the product that was purchased) and the merchant (e.g., the location of the transaction). The fraud detection system accesses historical transaction data from historical databases to validate the transaction request. For example, the fraud detection system accesses historical transaction data from a customer database, a payment database, a merchant database, and a card database.

The fraud detection system further generates a weight score for each of the data sources (e.g., the historical databases). The weight scores may be generated to prioritize data sources that contain a larger dataset or may otherwise provide a more accurate representation of the received transaction data. In some examples, the fraud detection system generates the weight scores for each of the data sources using a machine-learning model. After generating the weight scores, the fraud detection system generates a fraud score for the received transaction request. The fraud score is based on the historical transaction data and the weight scores for each of the data sources. If the fraud score is at or above a threshold score, the fraud detection system determines that the transaction is likely a fraudulent transaction and voids the transactions. If the fraud score is below the threshold score, the fraud detection system determines that the transaction is likely a valid transaction and processes the transaction as usual.

The disclosed fraud detection system provides technical advantages over existing methodologies by leveraging a technical solution that involves machine-learning techniques that allow for the analysis of large amounts of data (e.g., historical data) and accurate categorization the data (e.g., based on the weight scores) to determine a fraud score for a particular transaction.

Further details of the fraud detection system are described in the paragraphs below.

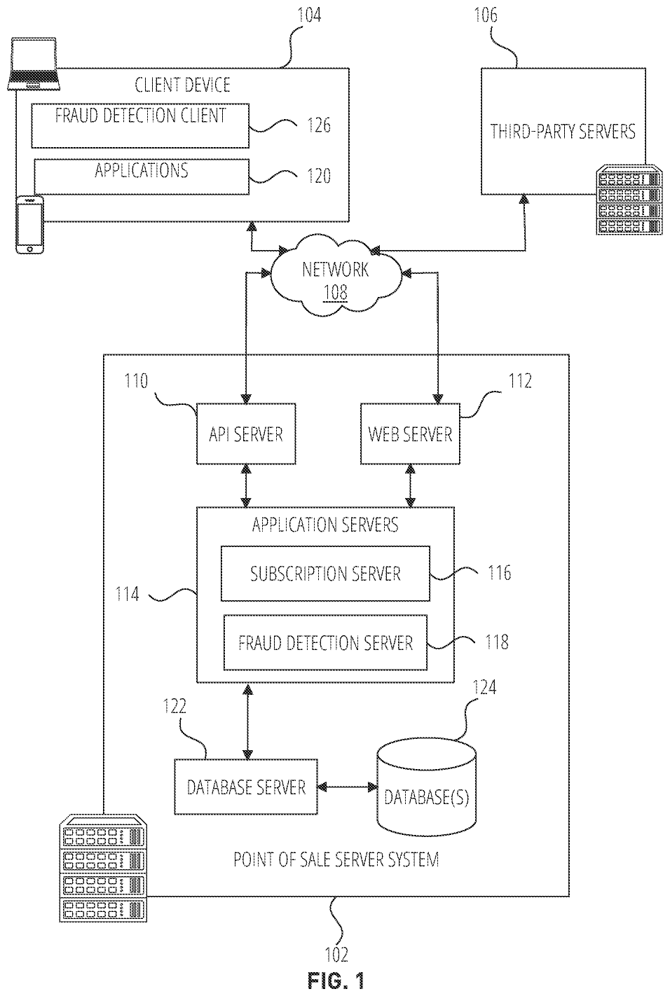

FIG. 1 is a block diagram showing an example point-of-sale system for conducting transactions over a network. The point-of-sale system includes multiple instances of a client device 104, each of which hosts a number of applications, including a fraud detection client 126 and other applications 120. Each fraud detection client 126 is communicatively coupled to other instances of the fraud detection client 126 (e.g., hosted on respective other client devices 104), a point-of-sale server system 102 and third-party servers 106 via a network 108 (e.g., the Internet). The applications 120 can also communicate with other locally-hosted applications 120 using Applications Program Interfaces (APIs).

The point-of-sale server system 102 provides server-side functionality via the network 108 to a fraud detection client 126. While certain functions of the point-of-sale system are described herein as being performed by either a fraud detection client 126 or by the point-of-sale server system 102, the location of certain functionality either within the fraud detection client 126 or the point-of-sale server system 102 may be a design choice. For example, it may be technically preferable to initially deploy certain technology and functionality within the point-of-sale server system 102 but to later migrate this technology and functionality to the fraud detection client 126 where a client device 104 has sufficient processing capacity.

The point-of-sale server system 102 supports various services and operations that are provided to the fraud detection client 126. Such operations include transmitting data to, receiving data from, and processing data generated by the fraud detection client 126. This data may include transaction data, customer data, product data, subscription data and provider data, as examples. Data exchanges within the point-of-sale server system 102 are invoked and controlled through functions available via user interfaces (UIs) of the fraud detection client 126.

Turning now specifically to the point-of-sale server system 102, an Application Program Interface (API) server 110 is coupled to, and provides a programmatic interface to, application servers 114. The application servers 114 are communicatively coupled to a database server 122, which facilitates access to a database 124 that stores data associated with the transactions processed by the application servers 114. Similarly, a web server 112 is coupled to the application servers 114 and provides web-based interfaces to the application servers 114. To this end, the web server 112 processes incoming network requests over the Hypertext Transfer Protocol (HTTP) and several other related protocols.

The API server 110 receives and transmits transaction data (e.g., commands and transaction data) between the client device 104 and the application servers 114. Specifically, the API server 110 provides a set of interfaces (e.g., routines and protocols) that can be called or queried by the on demand funding client 126 in order to invoke functionality of the application servers 114. The API server 110 exposes various functions supported by the application servers 114, including account registration, subscription creations and management, the processing of transactions, via the application servers 114, from a particular fraud detection client 126 to another fraud detection client 126.

The application servers 114 host a number of server applications and subsystems, including for example a subscription server 116, and a fraud detection server 118. The subscription server 116 implements functionalities for creating and managing subscriptions between multiple client devices 104.

The fraud detection server 118 provides functionalities for pre-declining fraudulent card transactions based on an evaluation of the transaction. Further details regarding the fraud detection server 118 are provided below.

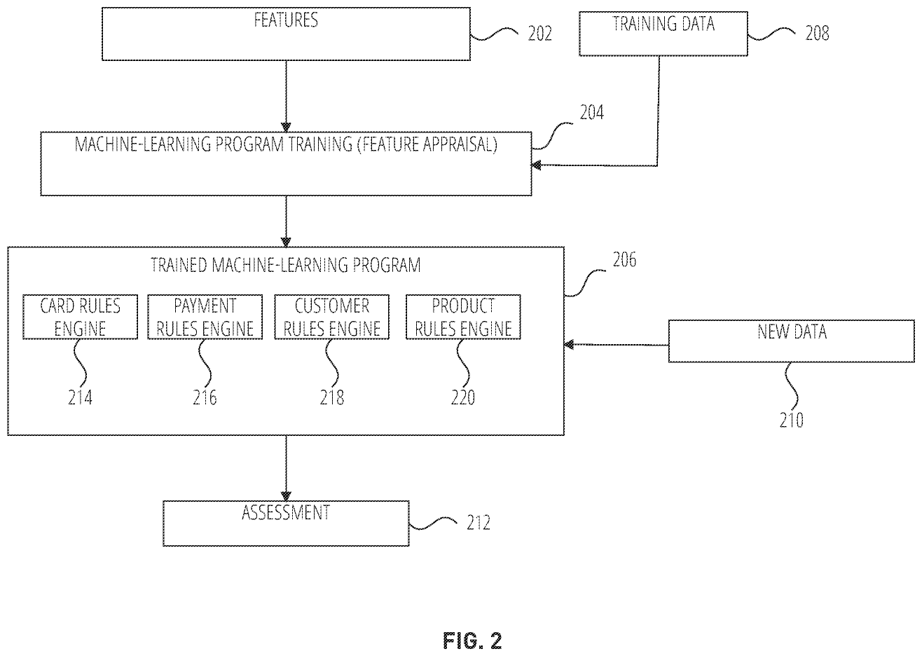

FIG. 2 illustrates the training and use of a machine-learning program, according to some embodiments. In some embodiments, machine-learning programs (MLPs), also referred to as machine-learning algorithms or tools, are utilized to perform operations associated with malware classification. Machine learning is a field of study that gives computers the ability to learn without being explicitly programmed. Machine learning explores the study and construction of algorithms, also referred to herein as tools, that may learn from existing data and make predictions about new data. Such machine-learning tools operate by building a model from example training data 208 in order to make data-driven predictions or decisions expressed as outputs or assessment 212. Although some embodiments are presented with respect to a few machine-learning tools, the principles presented herein may be applied to other machine-learning tools.

In some embodiments, different machine learning tools may be used. For example, Logistic Regression (LR), Naive-Bayes, Random Forest (RF), neural networks (NN), matrix factorization, and Support Vector Machines (SVM) tools may be used for classifying or scoring transaction data.

Two common types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number). In some embodiments, example machine-learning algorithms provide a prediction probability to classify an image as digitally manipulated or not. The machine-learning algorithms utilize the training data 208 to find correlations among identified features 202 that affect the outcome.

The machine-learning algorithms utilize features 202 for analyzing the data to generate an assessment 212. The features 202 are an individual measurable property of a phenomenon being observed. The concept of a feature is related to that of an explanatory variable used in statistical techniques such as linear regression. Choosing informative, discriminating, and independent features is important for effective operation of the MLP in pattern recognition, classification, and regression. Features may be of different types, such as numeric features, strings, and graphs. In one embodiment, the features 202 may be of different types. For example, the features 202 may be features of historical transaction data.

The machine-learning algorithms utilize the training data 208 to find correlations among the identified features 202 that affect the outcome or assessment 212. In some embodiments, the training data 208 includes labeled data, which is known data for one or more identified features 202 and one or more outcomes, such as detecting fraudulent transactions.

With the training data 208 and the identified features 202, the machine learning tool is trained during machine-learning program training 204. Specifically, during machine-learning program training 204, the machine-learning tool appraises the value of the features 202 as they correlate to the training data 208. The result of the training is the trained machine-learning program 206.

When the trained machine-learning program 206 is used to perform an assessment, new data 210 is provided as an input to the trained machine-learning program 206, and the trained machine-learning program 206 generates the assessment 212 as output. For example, when transaction data is received and the historical transaction data is accessed and the weights of the corresponding data sources are computed, the machine-learning program utilizes features of the historical transaction data to determine if the received transaction request is fraudulent or not.

In some examples the trained machine-learning program 206 includes a series of rules engines. Each rules engine includes a list of rules that the incoming transaction request is evaluated against before providing the assessment 212. For example, the trained machine-learning program 206 may include a card rules engine 214, a payment rules engine 216, a customer rules engine 218, and a product rules engine 220. The card rules engine 214 includes a set of rules that the card data associated with transaction request must be evaluated against before providing the assessment 212. The payment rules engine 216 includes a set of rules that the payment data associated with the transaction request must be evaluated against before providing the assessment 212. The customer rules engine 218 includes a set of rules that the customer data associated with the transaction must be evaluated against before providing the assessment 212. The product rules engine 220 includes a set of rules that the product data must be evaluated against before providing the assessment 212.

Although the described flow diagram below can show operations as a sequential process, many of the operations can be performed in parallel or concurrently. In addition, the order of the operations may be re-arranged. A process is terminated when its operations are completed. A process may correspond to a method, a procedure, an algorithm, etc. The operations of methods may be performed in whole or in part, may be performed in conjunction with some or all of the operations in other methods, and may be performed by any number of different systems, such as the systems described herein, or any portion thereof, such as a processor included in any of the systems.

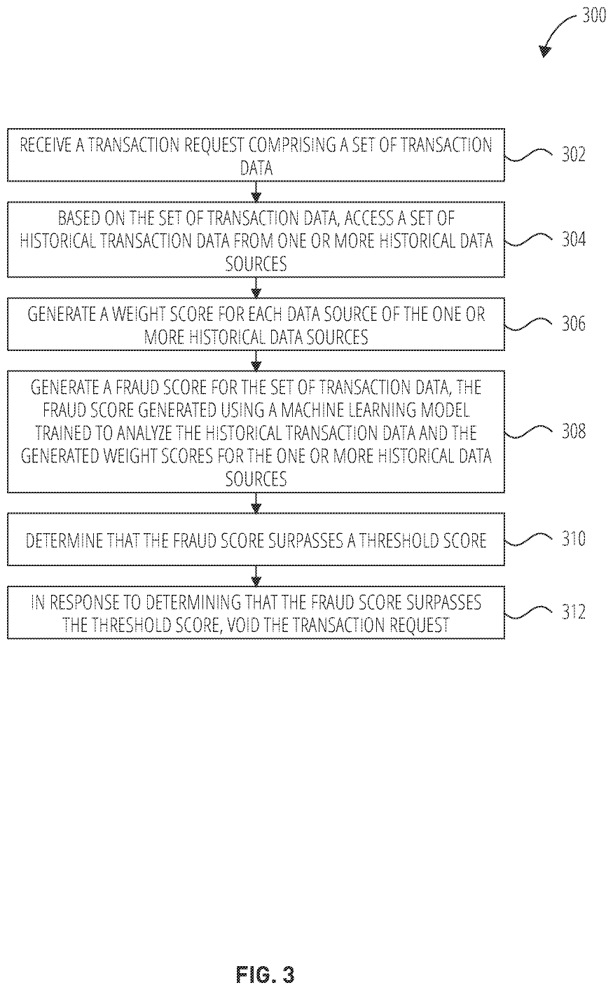

FIG. 3 is a method 300 for detecting fraudulent card transactions, according to some embodiments. In one example, the processor in a fraud detection client 126, the processor in the client device 104, the processor in the point-of-sale server system 102, the processor in the fraud detection server 118, or any combination thereof, can perform the operations in the method 300. In some examples, the operations of method 300 may be performed as a series of API calls.

At operation 302, the fraud detection server 118 receives, by a hardware processor, a transaction request. The transaction request comprises a set of transaction data. The set of transaction data may include card data, customer data, payment data, and product data. Card data is information about the credit card or debit card used in the transaction (e.g., account number, timestamp of transaction, etc.). Customer data includes information about the person completing the transaction. For example, the customer data may include personal identifiable information about the customer. The payment data includes information about the payments the customer has made. The product data includes data about the product that was purchased during the transaction. For example, the product data may include a quantity of the product that was purchased.

At operation 304, based on the set of transaction data, the fraud detection server 118 accesses a set of historical transaction data from one or more historical data sources. The historical data sources are databases that store previous transaction data. For example, the historical data sources include a card database that stores card data, a payment database that stores payment data, a customer database that stores customer data and a product database that stores product data. In some examples, the set of transaction data associated with the transaction request is stored in the historical data sources.

At operation 306, the fraud detection server 118 generates a weight score for each data source of the one or more historical data sources. For example, the weight score may be a value between 0 and 1. The weight score is dependent on the quality of data in the one or more historical data sources. The quality of data may be dependent on the amount of available data. For example, if the product database does not have any historical data about a particular product that was purchased as part of a transaction, then the fraud detection server 118 may assign it a weight score equal to zero. In another example, if the payment database has at least some datapoints describing previous transactions made by the particular customer who is completing the transaction, then the payment database may be assigned a score of 0.4. In some examples, the weight score is generated using a machine-learning model. The machine-learning model may generate the weight score by comparing the set of transaction data associated with the received transaction request with the historical transaction data from the one or more historical data sources.

At operation 308, the fraud detection server 118 generates a fraud score for the transaction request. The fraud score is generated using a machine-learning model trained to analyze the historical transaction data and the generated weight scores for the one or more historical data sources. For example, the machine-learning model receives the transaction data associated with the transaction request as input and analyzes the generated weight scores for the one or more historical data sources. The fraud detection server 118 subsequently outputs a fraud score based on the analysis. The machine-learning model may include the trained machine-learning program 206.

In some examples, based on the generated weight scores of the one or more historical data sources, the fraud detection server 118 removes a subset of data sources from the one or more historical data sources. For example, the fraud detection server 118 may remove any data source that is assigned a weight score of zero. In that example, the fraud detection server 118 does not analyze any data source that is assigned a weight score of zero when generating a fraud score.

At operation 310, the fraud detection server 118 determines that the fraud score surpasses a threshold score. The threshold score can be a lower bound or an upper bound that must be surpassed. In some embodiments, the fraud score must be below a threshold score and in some embodiments the fraud score must be above a threshold score.

At operation 312, in response to determining that the fraud score surpasses the threshold score, the fraud detection server 118 voids the transaction request. The generated fraud score may be value between zero and one. The threshold score may be 0.6. Thus, if the fraud score is at or above 0.6, the fraud detection server 118 may void the transaction. If the fraud score is between 0 and 0.5, the fraud detection server 118 may validate and process the transaction.

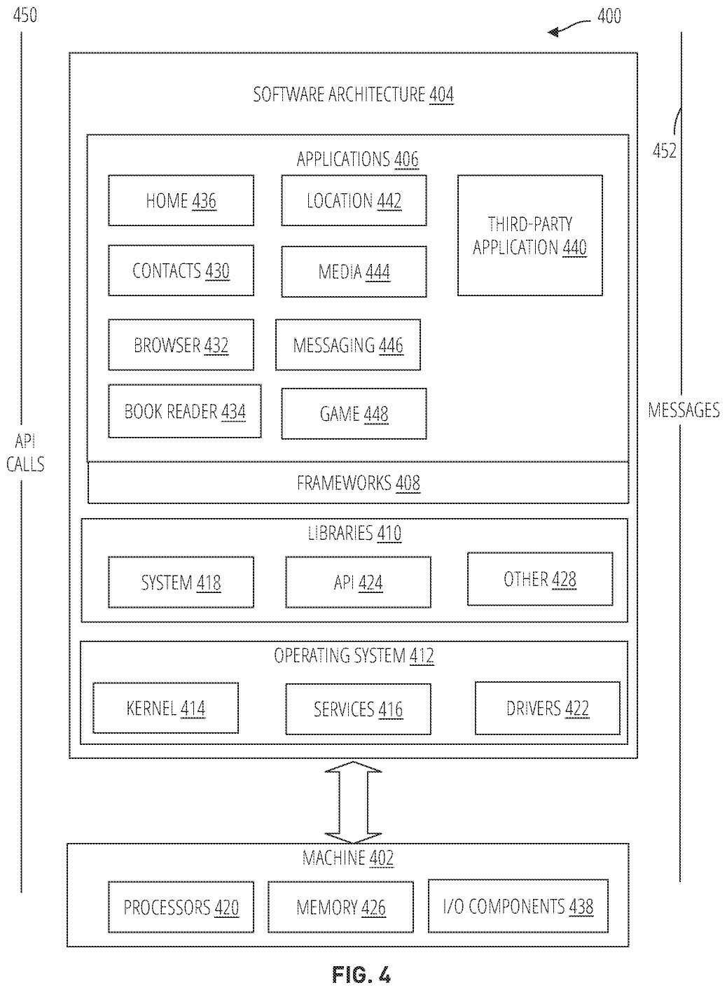

FIG. 4 is a block diagram 400 illustrating a software architecture 404, which can be installed on any one or more of the devices described herein. The software architecture 404 is supported by hardware such as a machine 402 that includes processors 420, memory 426, and I/O components 438. In this example, the software architecture 404 can be conceptualized as a stack of layers, where each layer provides a particular functionality. The software architecture 404 includes layers such as an operating system 412, libraries 410, frameworks 408, and applications 406. Operationally, the applications 406 invoke API calls 450 through the software stack and receive messages 452 in response to the API calls 450.

The operating system 412 manages hardware resources and provides common services. The operating system 412 includes, for example, a kernel 414, services 416, and drivers 422. The kernel 414 acts as an abstraction layer between the hardware and the other software layers. For example, the kernel 414 provides memory management, processor management (e.g., scheduling), component management, networking, and security settings, among other functionality. The services 416 can provide other common services for the other software layers. The drivers 422 are responsible for controlling or interfacing with the underlying hardware. For instance, the drivers 422 can include display drivers, camera drivers, BLUETOOTH® or BLUETOOTH® Low Energy drivers, flash memory drivers, serial communication drivers (e.g., Universal Serial Bus (USB) drivers), WI-FI® drivers, audio drivers, power management drivers, and so forth.

The libraries 410 provide a low-level common infrastructure used by the applications 406. The libraries 410 can include system libraries 418 (e.g., C standard library) that provide functions such as memory allocation functions, string manipulation functions, mathematic functions, and the like. In addition, the libraries 410 can include API libraries 424 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 410 can also include a wide variety of other libraries 428 to provide many other APIs to the applications 406.

The frameworks 408 provide a high-level common infrastructure that is used by the applications 406. For example, the frameworks 408 provide various graphical user interface (GUI) functions, high-level resource management, and high-level location services. The frameworks 408 can provide a broad spectrum of other APIs that can be used by the applications 406, some of which may be specific to a particular operating system or platform.

For some embodiments, the applications 406 may include a home application 436, a contacts application 430, a browser application 432, a book reader application 434, a location application 442, a media application 444, a messaging application 446, a game application 448, and a broad assortment of other applications such as a third-party application 440. The applications 406 are programs that execute functions defined in the programs. Various programming languages can be employed to create one or more of the applications 406, structured in a variety of manners, such as object-oriented programming languages (e.g., Objective-C, Java, or C++) or procedural programming languages (e.g., C or assembly language). In a specific example, the third-party application 440 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 440 can invoke the API calls 450 provided by the operating system 412 to facilitate functionality described herein.

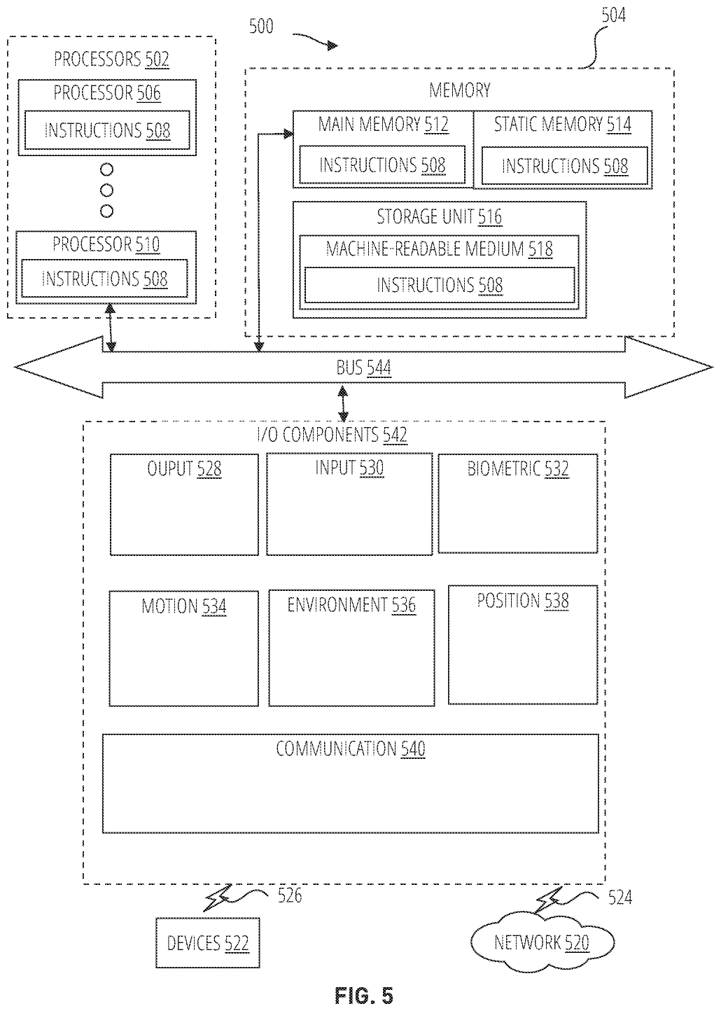

FIG. 5 is a diagrammatic representation of the machine 500 within which instructions 508 (e.g., software, a program, an application, an applet, an app, or other executable code) for causing the machine 600 to perform any one or more of the methodologies discussed herein may be executed. For example, the instructions 508 may cause the machine 600 to execute any one or more of the methods described herein. The instructions 508 transform the general, non-programmed machine 600 into a particular machine 600 programmed to carry out the described and illustrated functions in the manner described. The machine 600 may operate as a standalone device or may be coupled (e.g., networked) to other machines. In a networked deployment, the machine 600 may operate in the capacity of a server machine or a client machine in a server-client network environment, or as a peer machine in a peer-to-peer (or distributed) network environment. The machine 600 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 508, sequentially or otherwise, that specify actions to be taken by the machine 600. Further, while only a single machine 600 is illustrated, the term “machine” shall also be taken to include a collection of machines that individually or jointly execute the instructions 508 to perform any one or more of the methodologies discussed herein.

The machine 600 may include processors 502, memory 504, and I/O components 542, which may be configured to communicate with each other via a bus 544. For some embodiments, the processors 502 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 506 and a processor 510 that execute the instructions 508. The term “processor” is intended to include multi-core processors that may comprise two or more independent processors (sometimes referred to as “cores”) that may execute instructions contemporaneously. Although FIG. 5 shows multiple processors 502, the machine 600 may include a single processor with a single core, a single processor with multiple cores (e.g., a multi-core processor), multiple processors with a single core, multiple processors with multiples cores, or any combination thereof.

The memory 504 includes a main memory 512, a static memory 514, and a storage unit 516, both accessible to the processors 502 via the bus 544. The main memory 512, the static memory 514, and storage unit 516 store the instructions 508 embodying any one or more of the methodologies or functions described herein. The instructions 508 may also reside, completely or partially, within the main memory 512, within the static memory 514, within machine-readable medium 518 within the storage unit 516, within at least one of the processors 502 (e.g., within the processor's cache memory), or any suitable combination thereof, during execution thereof by the machine 600.

The I/O components 542 may include a wide variety of components to receive input, provide output, produce output, transmit information, exchange information, capture measurements, and so on. The specific I/O components 542 that are included in a particular machine will depend on the type of machine. For example, portable machines such as mobile phones may include a touch input device or other such input mechanisms, while a headless server machine will likely not include such a touch input device. It will be appreciated that the I/O components 542 may include many other components that are not shown in FIG. 5. In various embodiments, the I/O components 542 may include output components 528 and input components 530. The output components 528 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 530 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further embodiments, the I/O components 542 may include biometric components 532, motion components 534, environmental components 536, or position components 538, among a wide array of other components. For example, the biometric components 532 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 534 include acceleration sensor components (e.g., accelerometer), gravitation sensor components, rotation sensor components (e.g., gyroscope), and so forth. The environmental components 536 include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 538 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 542 further include communication components 540 operable to couple the machine 600 to a network 520 or devices 522 via a coupling 524 and a coupling 526, respectively. For example, the communication components 540 may include a network interface component or another suitable device to interface with the network 520. In further examples, the communication components 540 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 522 may be another machine or any of a wide variety of peripheral devices (e.g., a peripheral device coupled via a USB).

Moreover, the communication components 540 may detect identifiers or include components operable to detect identifiers. For example, the communication components 540 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 540, such as location via Internet Protocol (IP) geolocation, location via Wi-Fi® signal triangulation, location via detecting an NFC beacon signal that may indicate a particular location, and so forth.

The various memories (e.g., memory 504, main memory 512, static memory 514 and/or memory of the processors 502) and/or storage unit 516 may store one or more sets of instructions and data structures (e.g., software) embodying or used by any one or more of the methodologies or functions described herein. These instructions (e.g., the instructions 508), when executed by processors 502, cause various operations to implement the disclosed embodiments.

The instructions 508 may be transmitted or received over the network 520, using a transmission medium, via a network interface device (e.g., a network interface component included in the communication components 540) and using any one of a number of well-known transfer protocols (e.g., hypertext transfer protocol (HTTP)). Similarly, the instructions 508 may be transmitted or received using a transmission medium via the coupling 524 (e.g., a peer-to-peer coupling) to the devices 522.

“Computer-readable storage medium” refers to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Machine storage medium” refers to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Non-transitory computer-readable storage medium” refers to a tangible medium that is capable of storing, encoding, or carrying the instructions for execution by a machine.

“Signal medium” refers to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

What is claimed is:

1. A method comprising:
receiving, by a hardware processor, a transaction request that comprises a set of transaction data;
based on the set of transaction data, accessing, by the hardware processor, a set of historical transaction data from one or more historical data sources;
generating, by the hardware processor, a weight score for each data source of the one or more historical data sources to produce one or more weight scores;
generating, by the hardware processor, a fraud score for the set of transaction data, the fraud score generated using a machine-learning model trained to analyze the historical transaction data and the one or more weight scores for the one or more historical data sources;
determining, by the hardware processor, that the fraud score surpasses a threshold score; and
in response to determining that the fraud score surpasses the threshold score, voiding, by the hardware processor, the transaction request.

2. The method of claim 1, wherein the machine-learning model is a first machine-learning model, and wherein the one or more weight scores are generated using a second machine-learning model.

3. The method of claim 1, further comprising:
based on the one or more weight scores, removing, by the hardware processor, a subset of data sources from the one or more historical data sources.

4. The method of claim 1, further comprising:
storing, by the hardware processor, the set of transaction data in at least one of the one or more historical data sources.

5. The method of claim 1, wherein the one or more historical data sources comprise at least one of a customer database, a payment database, a card database, and a product database.

6. The method of claim 1, wherein the fraud score comprises a value between 0 and 1.

7. The method of claim 1, wherein the weight score for each data source of the one or more historical data sources is generated based on an amount of available data associated with each data source.

8. A system comprising:
a processor; and
a memory storing instructions that, when executed by the processor, cause the system to perform operations comprising:
receiving a transaction request that comprises a set of transaction data;
based on the set of transaction data, accessing a set of historical transaction data from one or more historical data sources;
generating a weight score for each data source of the one or more historical data sources to produce one or more weight scores;
generating a fraud score for the set of transaction data, the fraud score generated using a machine-learning model trained to analyze the historical transaction data and the one or more weight scores for the one or more historical data sources;
determining whether the fraud score surpasses a threshold score; and
in response to determining that the fraud score surpasses the threshold score, void the transaction request.

9. The system of claim 8, wherein the set of transaction data comprises at least one of customer data, payment data, card data, and product data.

10. The system of claim 8, wherein the machine-learning model is a first machine-learning model, and wherein the one or more weight scores are generated use a second machine-learning model.

11. The system of claim 8, wherein the one or more weight scores are values between 0 and 1.

12. The system of claim 8, wherein the operations further comprise:
based on the one or more weight scores, removing a subset of data sources from the one or more historical data sources.

13. The system of claim 8, wherein the operations further comprise:
storing the set of transaction data in at least one of the one or more historical data sources.

14. The system of claim 8, wherein the one or more historical data sources comprise at least one of a customer database, a payment database, a card database, and a product database.

15. The system of claim 8, wherein the fraud score comprises a value between 0 and 1.

16. A non-transitory computer-readable storage medium, the computer-readable storage medium including instructions that when executed by a processing device, cause the processing device to perform operations comprising:
receiving a transaction request that comprises a set of transaction data;
based on the set of transaction data, accessing a set of historical transaction data from one or more historical data sources;
generating a weight score for each data source of the one or more historical data sources to produce one or more weight scores;
generating a fraud score for the set of transaction data, the fraud score generated using a machine-learning model trained to analyze the historical transaction data and the one or more weight scores for the one or more historical data sources;
determining whether the fraud score surpasses a threshold score; and
in response to determining that the fraud score surpasses the threshold score, voiding the transaction request.

17. The computer-readable storage medium of claim 16, wherein the set of transaction data comprises at least one of customer data, payment data, card data, and product data.

18. The computer-readable storage medium of claim 16, wherein the machine-learning model is a first machine-learning model, and wherein the one or more weight scores are generated use a second machine-learning model.

19. The computer-readable storage medium of claim 16, wherein the operations further comprise:
based on the one or more weight scores, removing a subset of data sources from the one or more historical data sources.

20. The computer-readable storage medium of claim 16, wherein the operations further comprise:
storing the set of transaction data in at least one of the one or more historical data sources.
